(19) United States
(12) Patent Application Publication
(10) Pub. No.: US 2025/0090918 A1
(43) Pub. Date: Mar. 20, 2025

(54) Golf Measuring System

(71) Applicants: David Hunter, Edinburgh (GB); Shot Scope Technologies Limited, Edinburgh (GB)

(72) Inventor: David Hunter, Edinburgh (GB)

(21) Appl. No.: 18/729,472

(22) PCT Filed: Jan. 16, 2023
(86) PCT No.: PCT/GB2023/050072

§ 371 Date: Jul. 16, 2024

(30) Foreign Application Priority Data
Jan. 18, 2022 (GB) 2200608.4

(51) Int. Cl. A63B 60/46; A63B 24/00; A63B 69/36

(52) U.S. Cl. CPC A63B 60/46; A63B 24/0021; A63B 69/3632; A63B 2024/0056; A63B 2060/464; A63B 2209/08; A63B 2220/13; A63B 2220/833

(57) ABSTRACT

A device and system for measuring and calculating distance on a golf course involving a laser rangefinder device, magnetic detachable global positioning device, magnetic detachable radio frequency device, magnetic detachable golf statistical performance tracking device. The combination of devices deliver a golf distance and golf statistical performance tracking system capable of identifying the exact position of a golf shot and recording club used to hit the ball, latitude and longitude physical location and golf statistical performance data and information for golf. At least one object sensor and/or radio frequency club identification tag inserted and/or embedded in the grip or a golf club and/or the golf club component. One or more of the detachable devices comprise of at least one object or combination of object reading radio frequency sensor and/or swing detection sensor and/or shock sensor and/or vibration sensor and/or accelerometer and/or golf club impact sensor and/or magnetometer sensor and/or sound sensor; and the system is configured to at least partially detect a golf swing and/or golf club strike on the ball and/or vibrations as a result of contact with a ball and/or sound generated by contact with a golf ball object. Further use of the detachable device identifying a golf shot delivers a system to collect statistical and performance data and performance information through monitoring an action, such as a golf swing and/or golf shot and/or recognition of a shot by a golfer and/or collection of the shot event by a golfer.

### CROSS-REFERENCE TO RELATED APPLICATIONS

This application is a national phase entry under 35 U.S.C. § 371 of International Patent Application PCT/GB2023/050072, filed Jan. 16, 2023, designating the United States of America and published in English as International Patent Publication WO 2023/139350 on Jul. 27, 2023, which claims the benefit under Article 8 of the Patent Cooperation Treaty to United Kingdom Patent Application Serial No. 2200608.4, filed Jan. 18, 2022, the entireties of which are hereby incorporated by reference.

### FIELD OF DISCLOSURE

The present disclosure describes a golf measuring system, particularly though not exclusively a golf measuring system with at least one detachable device configured to act as a location device and/or a golf statistical performance tracking device.

### BACKGROUND

In the game of golf, it is often desirable for a golfer to measure a distance from a physical location on the golf course to at least one of: a hole, flagstick or pin location and, in parallel, a distance from the exact same physical location on the golf course to a at least one of: a golf green, golf bunker, golf hazard and/or the like. In addition, it can also be desirable to, in parallel, record statistical information about personal performance through, for example, at least one of: statistical data, metric data, performance insight data or scoring data. Traditionally, golfers have used both rudimentary yardage books to measure distance and rudimentary scorecards to record score, but it has been very difficult to record in depth information such as a precise location of where a shot was taken or a club that was used. Recently, the prevalence of portable devices such as smartphones has allowed additional information to be recorded on a digital scorecard. However, current solutions require the player to manually enter data into an electronic device or onto a piece of paper. Both actions interrupt the natural flow of a round of golf.

During a professional golfing tour, a system such as Shot Link (PGA Tour Inc.) may be used, in which a large number of volunteers manually record information on a golfer's performance. This involves the volunteers entering information on shots taken, as well as using laser distance measures at fixed locations to triangulate the current position of the golfer's ball. The whole system is supported by a network of computers and data processors. Whilst this gives a high level of accuracy of position, and other manually entered information, it does not scale to provide feedback to the individual golfer.

Additionally, such systems require over ten electronic recording devices on every golf hole. This is an expense and practicality not achievable for the individual golfer.

### SUMMARY OF THE INVENTION

It is an object of at least one example of the present disclosure to provide an improved or alternative device for display of distance to features on a golf course such as a golf pin, golf hole, golf green, golf bunker, golf hazard or physical location on the golf course and an improved device for monitoring and recording information about personal performance, e.g. through statistical data, metric data, performance insight data or scoring data.

At least some examples of the present disclosure relate to a golf rangefinder system. The golf rangefinder system may comprise a rangefinder device, which may be a laser rangefinder device, such as a golf laser rangefinder device. The golf rangefinder device may comprise an optical viewing system that may comprise at least one optical lens, e.g. for viewing an environment, which may comprise the golf course, by eye therethrough. The golf rangefinder device may comprise a golf yardage display, such as a switchable display. The display may be a colour display.

The golf rangefinder system may comprise or be configured to connect to a second device, e.g. to physically connect to the second device. The second device may comprise a positioning system for determining a current location of the second device and/or the second device may comprise an automatic golf statistics performance tracking device. The positioning system may comprise a global positioning system, such as GPS, Galileo, GLONASS, BeiDou and/or any other suitable satellite positioning system. The golf rangefinder device may be configured for data communication with the second device, e.g. with the positioning system and/or the automatic golf statistics performance tracking device. The golf rangefinder device may be releasably connectable, e.g. detachable and re-connectable, to the second device, e.g. physically releasably connectable, e.g. detachable and re-connectable to the second device. The golf rangefinder device may be releasably connectable to the second device via a magnetic connector. The second device, e.g. the device comprising the global positioning and automatic golf statistics performance tracking device, may be a magnet mounted detachable device. For example, the second device may be removed and attached to a golfers belt buckle or pocket or golf bag or golf kart.

The second device, e.g. the positioning system and/or the automatic statistics performance tracking device, may communicate with club identification or radio frequency identification tags, which may be inserted into the grip of a golf club to identify the event of a golf shot. The detachable second device may be configured for identifying a golf shot, and may deliver a system to collect statistical and performance data and performance information through monitoring an action, such as a golf swing or golf shot or recognition of a shot by a golfer.

According to a first aspect of the present disclosure is a golf system, which may comprise or be in the form of a device, such as a hand-held device and/or user device. The golf system may be or comprise a system for measuring distance on a golf course and automatically or partially automatically gathering information on golf statistical performance of an action involving a golfer swinging a golf club or golf equipment to hit or strike or make contact with a golf ball object.

The golf system may comprise at least one positioning system for determining a location or position of the golf system, e.g. for determining the location or position of the golf system on the golf course. The positioning system may be a positioning device, such as a magnetic detachable global positioning device. The golf system may comprise at least one rangefinder system for measuring the distance on the golf course. The rangefinder system may be a device such as a golf laser rangefinder device. The golf system may comprise at least one statistics collection system for automatically or partially automatically gathering the information on golf statistical performance of the action involving the golfer swinging a golf club or golf equipment to hit or strike or make contact with a golf ball object. The statistics collection system may be a device, such as a magnetic detachable performance tracking device.

The golf device may comprise a first device and a second device, which may be releasably connected or connectable together, e.g. detachable and re-connectable together. The first device may comprise one or two of: the at least one positioning system; the at least one rangefinder; and/or the at least one statistics collection system. The second device may comprise one or two other of: the at least one positioning system; the at least one rangefinder; and/or the at least one statistics collection system. That is, one of: the at least one positioning system; the at least one rangefinder; or the at least one statistics collection system may be provided in the first device and one or both other of the at least one positioning system; the at least one rangefinder; and/or the at least one statistics collection system may be provided in the second device. The first device and the second device may be releasably connected or connectable together by magnetic force, e.g. detachable and re-connectable together using magnetic force, e.g. via a magnetic coupling on one or both of the first device and/or the second device.

Having the first and second devices detachable and re-attachable from each other provides particular benefits. For example, when both devices are connected together, then satellite positioning technology can be combined with optics technology to deliver more accurate distances to a specific feature on the golf course. When connected, the single physically connected device is easier to carry, transport and/or store. When connected, the two devices can, through communication, locate their last GPS location and transmit the information to the user mobile phone and account. However, as the first and second devices are detachable, then this allows both the rangefinder and the positioning system and statistics collection system/stroke analyser to be used separately or independently. The positioning system and statistics collection system/stroke analyser can be mounted on a belt, golf trolley or magnetically connected to a golf trolley making it easier to obtain distance information on the golf course and/or record shots through “tagging” of a shot during play, which may be harder to do if they were incorporated in a more bulky rangefinder. As such, another advantage is that the positioning system and statistics collection system/stroke analyser can be carried in a standard trouser, shorts or jacket pocket for ease of use and convenience, thereby making access to golf distance information easy and quick and recording of golf shots through “tagging” fast and seamless.

The rangefinder system may be or comprise a golf rangefinder system. The golf system may comprise a rangefinder device such as a laser rangefinder device. The positioning system may comprise a global positioning system, such as GPS, Galileo, GLONASS, BeiDou and/or any other suitable satellite positioning system. The at least one statistics collection system may comprise a statistical performance tracking device. The at least one statistics collection system may comprise a performance, metric and/or scoring tracking system. The at least one statistics collection system may be configured to communicate with club identification or radio frequency identification tags, which may be inserted into the grip of a golf club to identify the event of a golf shot. The at least one statistics collection system may be configured for identifying a golf shot, and may deliver a system to collect statistical and performance data and performance information through monitoring an action, such as a golf swing or golf shot or recognition of a shot by a golfer.

The first device may comprise the at least one rangefinder system. The second device may comprise the positioning system and/or the at least one statistics collection system.

The first device may be configured to connect to the second device, e.g. to physically connect to the second device. The first device may be releasably connectable, e.g. detachable and re-connectable, to the second device, e.g. physically releasably connectable, e.g. detachable and re-connectable to the second device. The first device may be releasably connectable to the second device via a magnetic connector. The second device, e.g. the device comprising the global positioning and automatic golf statistics performance tracking device, may be a magnet mounted detachable device. For example, one or both of the first device and/or the second device may comprise a magnetic connector, which may be configured to releasably and magnetically connect to a metallic connector or another magnetic connector on the other of the first or second device. The second device may comprise a secondary connector, which may be a physical connector, such as a hook, karabiner, clip, loop of the like. For example, the second device may be removed and attached to a golfers belt buckle or pocket or golf bag or golf kart, e.g. via the secondary connector.

The first device may be configured for data communication with the second device, e.g. the golf rangefinder system may be configured to communicate with the positioning system and/or the automatic golf statistics performance tracking device. The first device may be configured for wireless, e.g. radiofrequency, data communication with the second device. The first and/or second device may optionally be configured for wireless communication with a remote system, such as a data centre, server, or other remote data storage and/or processing service, but all processing and/or data storage may be performed locally on the golf system. The first and/or second device may optionally be configured for wireless communication, such as radio frequency wireless communication or other near field communication, with a peripheral device, such as one or more ID tags, which may be inserted or installed in the golf grip or golf club, and may serve to identify the golf club and/or indicate that a shot is to be played. The first and/or second device may optionally be configured to communicate with each other when coupled, attached or connected together and/or when detached.

The first and/or second device may optionally be configured to communicate with each other to share, e.g. to transmit and/or receive, data that comprises at least one of: score, position on the course, distance to the pin, health information, statistics information, equipment information, altitude data, suggested club data, recognition of physical connection between the first device and the second device, e.g. between the rangefinder and the positioning system/statistics collection system/stroke analyser device, information transmitted to a mobile phone for safety or the event a device is lost, golf game requirements, and/or the like.

The golf system may be configured to measure the physical distance between a golfer's position and an other physical position on the golf course. The golf system may be configured to record the physical position of the golfer and/or details of the golfer's performance automatically. The positioning system, which may be provided in the second device, may further determine and deliver improved distance accuracy between the golfer's physical position and the other physical position on the golf course, e.g. to enhance or supplement a distance between the golfer's physical position and the other physical position on the golf course determined using the rangefinder system, which may be provided in the first device. The ID tags, e.g. radio frequency identification tags inserted or installed in the golf grip or golf club, may communicate wirelessly, e.g. through radio frequency, the event of a golf shot and/or physical location or position of a golf shot and club used to play a golf shot, to the golf system, which may be to at least the statistics collection system, which may be provided in the second device.

Data, such as one or more of: physical distance information, physical latitude and/or longitude information, golf performance statistics, metrics or insights information and/or the like, may be stored within a memory of the golf system, which may be a memory of the rangefinder system, a memory of the positioning system, and/or a memory of the statistics collection system. The golf system may comprise at least one viewer. Distance information determining the physical location of a golfer and/or the other physical position on a golf course may be displayed on the at least one viewer. The at least one viewer may be comprised in one or more of: the rangefinder system, the positioning system, and/or the statistics collection system. The golf device may comprise at least one radio frequency golf club identification antenna, which may be embedded in one or more of: the rangefinder system, the positioning system, and/or the statistics collection system. The golf system may be configured to, using the at least one radio frequency golf club identification antenna, to scan and/or record through the transmission of an electrical or electronic or magnetic field or electromagnetic wave or field or power magnetic field to identify, electrically power and communicate with the ID tag, i.e. a passive radio frequency club identification tag, installed, inserted or embedded in a golf grip or golf club. The golf system may comprise at least one processing unit, which may comprise at least one processor. The at least one processing unit may be provided in one or more of the first device and/or the second device. The at least one processing unit may be provided, e.g. embedded, in one or more of: the rangefinder system, the positioning system and/or the statistics collection system. Data such as distance and performance tracking statistical data, metric data, insights data, and/or the like, may be delivered to the at least one processing unit, which may determine and calculate golf scoring and/or statistical information to deliver a performance tracking insights system. The performance tracking insights system may determine at least one golf statistic and/or golf metric based on the data, wherein the at least one golf statistic or golf metric may be or comprise at least one of: identify the location of at least one or every golf shot, score on every hole, type of golf club used to strike a golf ball, statistical information for every hole, round or season and encompassing map detailing the layout of the golf course or golf hole, and/or the like.

The methods described above can have any sub-combination of the following features:

The golf system, e.g. the second device and optionally the statistics collection system, may be configured to automatically detect the exact moment a golf club strikes a golf ball. The golf system, e.g. the second device, may comprise at least one object sensor, such as an object contact sensor. One or more of the at least one object contact sensors may be or comprise a shock and/or vibration sensor, such as an accelerometer. One or more of the at least one object contact sensors may be or comprise a sound sensor, such as a MEMS sound sensor or other microphone. The system may comprise both the at least one shock and/or vibration sensor and the at least one sound sensor.

The golf system, e.g. the second device and optionally the statistics collection system, may be configured to at least partially detect the event of the golf club striking a golf ball.

The system may comprise of one or more portable devices may be configured to connect and/or detach using a magnet or magnetic force, e.g. to connect and/or detach to each other using a magnet or magnetic force. At least one of the one or more portable devices may be the first device and at least one other of the one or more portable devices may be the second device. At least one or all of the one or more portable devices, e.g. at least the first device and/or the second device, may be detachable devices, e.g. detachable from each other. At least one or all of the one or more portable devices, e.g. at least the first device and/or the second device, may comprise a magnet or other magnetic coupling. At least one or all of the portable devices, such as the first device and/or the second device, may be or comprise of a wearable device or mountable device on a wrist, hand, forearm, belt, bag or pocket of the golfer or sports player. The at least one portable device, e.g. the second device, may be or comprise of a radio frequency antenna.

At least one or all of the portable devices, such as the second device, may be or comprise of shock sensor and/or vibration sensor and/or accelerometer and/or golf club impact sensor and/or magnetometer sensor and/or sound sensor. The golf system, e.g. the second device, may be configured to at least partially detect a golf swing and/or golf club strike on the ball and/or vibrations as a result of contact with a ball and/or sound generated by contact with a golf ball object.

The golf system, e.g. the second device optionally the statistics collection system, may automatically detect when a golf club is being swung, or in the hand, or being held by a golfer. The golf system, e.g. the second device optionally the statistics collection system, may be configured to detect a change of golf club and/or golf equipment and/or sports equipment and may further identify the equipment type. The golf system, e.g. the second device optionally the statistics collection system, may be configured to detect the event of a golfer swinging the golf club.

The golf system, e.g., the first device optionally the golf rangefinder system and/or the second device optionally the positioning system, may be or comprise of a device for measuring distance in golf. Optionally the first device optionally the golf rangefinder system may be configured to measure distance in golf with another of the at least one devices, e.g. a sub-device, such as the second device affixed, affixable, mountable or detachable to and/or from the first device. The second device may use magnets or magnetic force to affix, mount or attach to the distance measuring device, e.g. to the first device. At least one of the one or more portable devices, e.g. the first device and/or the second device, may utilise radio frequency and wireless communication. At least one or all of the one or more portable devices, e.g. the second device such as the statistics collection system, may render the device capable to detect and/or identify a tag or multiple tags that identify a golf club type or golf club equipment, e.g. utilising radio frequency and/or Radio Frequency Identification (RFID). At least one or all of the one or more portable devices, e.g. at least the first device and/or the second device, may utilise wireless communication sensors; Wi-Fi and/or Bluetooth and/or Near Field Communications and/or Global Positioning System (GPS).

The golf system, e.g. the second device optionally the statistics collection system, may comprise of a radio frequency tag reader antenna. The radio frequency tag reader may be or comprise of a tag reader antenna. The golf system, e.g. the second device optionally the statistics collection system, may comprise of a tag reader circuit. The tag reader circuit maybe or comprise of the tag reader antenna, which may comprise a radio frequency antenna for transmitting and/or receiving electromagnetic power and/or data and/or information. The tag reader circuit may comprise of electronics to manage and/or deliver electrical signals and/or electrical power to the radio frequency antenna. The tag reader may receive data from and/or send data to the at least one radio frequency tag and/or golf club identification tag and/or golf club and/or golf equipment.

The golf system, e.g. the second device optionally the statistics collection system, may comprise a tag reader, which may comprise the tag reader circuit. The tag reader may utilise a corresponding mode of communication to that used by the at least one tag. The tag reader may be or comprise a wireless tag reader. The tag reader may comprise the tag reader antenna for transmitting and/or receiving electromagnetic radiation. The tag reader antenna may be or comprise an RF or NFC antenna. The tag reader may receive data from and/or send data to the at least one tag.

The tag reader may be comprised in or mounted or mountable on the at least one portable device and/or detachable device (e.g. the at least one wearable device). The tag reader may be comprised in or mounted or mountable on the first device and/or second device. For example, the tag reader may be comprised in or mounted or mountable on the wrist worn device and/or mounted device on the golfer and/or attached device to clothing and/or attached device to belt and/or attached device to golf bag. The golf system may be configured such that all or part of the radio frequency tag reader and/or club identification tag reader is located or locatable on an underside of a device lens and/or a Liquid Crystal Display (LCD) and/or a device logo and/or a device information locational on the device front.

The tag reader may comprise of a radio frequency tag reader or golf club identification reader configured such that all or part of the tag reading circuit is located or locatable on the underside of the device logo and/or device information.

The system may comprise of a device, such as the first and/or second device, with Radio Frequency Identification (RFID) antenna embedded on the lens and/or embedded in the window and/or embedded in the front and/or embedded in the device logo. When the golfer holds the golf club the RFID antenna may communicate with the radio frequency tag and/or golf club identification tag and/or the golf equipment to detect the player and/or golfer is holding the golf club and identify which club is being held.

The system may comprise of a device, such as the first device, for measuring distance in golf with a sub-device, such as the second device, affixed, affixable, mountable or detachable to the first device. The system may use magnets or magnetic force to affix, mount or attach the sub-device or second device to the distance measuring device, e.g. the first device. The sub-device or second device or at least one other detachable device may comprise or otherwise utilise wireless communication sensors; Wi-Fi and/or Bluetooth and/or Near Field Communications and/or Global Positioning System (GPS).

The golf system may comprise of multiple golf distance measuring devices affixable, mountable or attachable to each and/or all golf distance device within the system. The golf system may use magnets or magnetic forces to affix, mount or attach the golf distance measuring devices, e.g. to affix, mount or attach the golf distance measuring devices together. At least one of the golf distance measuring devices may be or comprise or be comprised in the golf rangefinder system and/or the first device. At least one of the golf distance measuring devices may be or comprise or be comprised in the positioning system and/or the second device.

The golf system may comprise of one or more magnets providing affixable, mountable or attachable function to multiple portable golf distance measuring devices and/or portable golf performance tracking devices.

The golf system may comprise a swing detector. The swing detector may comprise or communicate with the at least one swing sensor. The swing detector may comprise a reactive system for real-time detection of swing motions and optionally may act to activate the at least one object sensor. The swing detector may comprise a non-reactive system, which monitors the data from the at least one swing sensor to detect when a swing happened. The swing detector may comprise a matched filter or the like. The swing detector may be implemented in the second device, e.g. in the statistics collection system, and/or may be distributed over, for example, the second device and at least one other device such as one or more of: a remote device such as a user device such as a mobile phone, and/or a remote server and/or the first device and/or the like.

The swing detector may comprise a finite state machine, or the like. That is to say, the swing detector may monitor the at least one swing sensor, for predefined motion ranges in a predefined order and optionally in predefined time windows. In this way, the swing detector may be configured with one or more patterns of movements which nominally describe a swing, and may monitor the at least one swing sensor to detect such motions or patterns. Such patterns may be or comprise ranges or patterns in the spatial and/or temporal domains. The swing detector may monitor the at least one swing sensor for readings within a defined range, which may indicate a motion is occurring, and may then monitor for another motion indicative of the next stage of a swing. This process may be repeated to monitor for and detect a swing motion. Each step of the motion may be allocated a time window. If the step of the motion is not detected within that time window, the swing detector may reset back to the start of the motion.

The swing detector may be configured to detect a golf swing, i.e. using a golf club. The swing detector may be configured with one or more patterns which nominally describe swing motions, such as golf swings. For example, the system may detect when the player or user (e.g. a golfer) is initiating a back swing by monitoring the at least one swing sensor and detecting when the readings are within a predefined range associated with initiating a back swing. The system may then begin looking for sensor readings which indicate that a back swing is in progress. A time window may be allocated for this, and if no matching sensor readings are found within this time window, the process may reset. If a back swing is detected, the system may start to look for sensor readings which indicate a transition phase of the swing is occurring, and so on. During the portions of the swing where contact with a ball would be expected, the system may activate and/or monitor the at least one object sensor.

As a related example, the swing detector may be activated by a golfer gripping a club, which may be identifiable as a putter, e.g. using an identifier associated with that club. The swing detector may detect that the golf club is being moved, or held, in a position or motion indicative of a putting shot.

The swing detector may be configured to monitor for different types of swing, optionally simultaneously. The swing detector may be configured to identify the type of object or equipment (e.g. putter, driver, pitching wedge, etc.) being gripped or held by the player or user and may be configured to selectively monitor for one or more types of swing associated with that object or equipment.

The swing detector may be configured to detect motions such as a tennis swing, or a kicking motion.

The information gathered by the golf system may comprise one or more of: location data, time data, equipment type and/or ID data, swing data, swing type data, shot count, and/or internal variables from the at least one portable device. The swing data may comprise or be derived from readings from the at least one swing sensor and/or the at least one object sensor. The swing type data may comprise or be derived from the at least one swing sensor, the at least one object sensor and/or internal variables of the at least one portable device. For example, the swing detector may be comprised within the portable device, and may be configured to monitor for several different motion types. The information may then comprise swing type data which may include information on the type of motion detected and/or whether or not an object contact was detected during the motion.

The golf system may comprise data storage for storing the information. The data storage may comprise RAM, EEPROM, Flash memory, magnetic storage, solid state drive (SSD) storage, or the like. The data storage may comprise or be comprised in a microcontroller, or may comprise separate integrated circuits (ICs). The data storage may comprise a removable storage interface, such as an interface for microSD cards, SD cards, USB memory drives or the like. The data storage may comprise one or more data storage instances, each of which comprises EEPROM, flash memory, an SD card interface and/or the like.

The golf system, e.g. the first device and/or the second device, may comprise one or more communication interfaces, such as Bluetooth, Wi-Fi, NFC, USB, and/or the like. The golf system may send and/or receive data through the one or more communication interfaces. The golf system may send all or part of the information through the one or more communication interfaces.

The information gathered by the golf system or received data may comprise location information, time information, and/or other contextual information. The information gathered by the golf system or received data may comprise additional information on the performance of the action. For example, the golf system may receive location and time information from a consumer device, such as GPS data. The system may receive information entered by the user into the consumer device. The consumer device May be the user device, such as a mobile phone. That is, the user device and the consumer device may be used interchangeably herein.

For example, the golf system may communicate with a smartphone or other electronic consumer device through the communication interface. It may then send the information on performance of the sport to the consumer device. The golf system may be or comprise a golf monitoring system, and may receive information entered by the user relating to score, golf club type, penalties, corrections, and the like.

The golf system, e.g. the positioning system, may comprise a GPS location device or other device for providing location information. The GPS location device may provide the location and/or time information.

The golf system, e.g. the statistics collection system, may be able to differentiate between practice swings and real swings, wherein contact with the object occurs in a real swing. The golf system, e.g. the statistics collection system, may use the one or more object contact sensors to determine whether or not contact with the object occurs during a swing. The information may comprise information only on real swings and/or on practice swings as well as real swings.

The golf system, e.g. the statistics collection system, may use the location information from a cluster of swings in order to determine the final location of a real swing. The cluster of swings may be clustered in the time and/or spatial domains. The cluster of swings may comprise a real swing and one or more practice swings. The system may average, smooth or otherwise utilise the location information from each of the swings in the cluster of swings in order to determine the final location. For example, in a game of golf a player will often take numerous practice swings before taking a real swing. These practice swings tend to be close proximity to where the player's ball is and hence where the real swing will occur. Using the location information from a cluster of swings, including a number of practice swings and a real swing, may allow a more accurate determination of the location where the real swing was taken.

The golf system, e.g. the first device and/or the second device, may comprise one or more user interfaces. The one or more user interfaces may comprise buttons, scrollers, touch screens, screens, viewers, rotary switches and/or the like, for example push buttons, potentiometers or capacitive sensors. The one or more user interfaces may comprise a touch screen. The one or more user interfaces may comprise voice and/or gesture control. The one or more user interfaces may comprise or use the one or more object contact sensors, for example accelerometers, gyros and/or microphones. The one or more user interfaces may comprise or communicate with the one or more communication interfaces.

The golf system, e.g. the first device and/or the second device, optionally the statistics collection system, may receive data from the one or more user interfaces. The data received from the one or more user interfaces may comprise additional information on the performance of the action. For example, the golf system may be or comprise a golf monitoring system, and may comprise a push button on a wearable device, which the player may push to register that they have received a penalty. The data received may relate to the control of the golf system, for example starting/stopping or pausing/resuming monitoring.

The golf system, e.g. the first device and/or the second device, may comprise one or more output devices. The one or more output devices may be comprised in the one or more portable devices. The one or more output devices may comprise LEDs, display screens, speakers, vibrating motors, or the like. The one or more output devices may comprise or communicate with the one or more communication interfaces.

The golf system may send data to the one or more output devices. The data sent to the one or more output devices may comprise all or part of the information on the performance, information of the state of the system, contextual information such as time or location, and/or the like.

For example, the golf system may use the one or more output devices to indicate if a shot or real swing has been detected and/or a manual recording of a real swing and/or real golf shot. If the player or user has just made a very soft shot, the player or user may wish to confirm that it has been detected. Should detection have failed, the player or user may log the shot using the one or more user interfaces. In a related example, the golf system may detect that a player or user is holding a piece of equipment, but there may be uncertainty in the detection of a real shot. The golf system may then alert the player or user to this uncertainty using the one or more output devices, and may request clarification from the player or user. The clarification may comprise the player or user interacting with the one or more user interfaces, for example pushing a button and/or manual record using radio frequency tag and/or manual record using club identification tag, if a shot did or did not place. The clarification may comprise the system displaying to the player or user its assumption on shot detection. The player or user may then confirm or correct the assumption. Confirming the assumption may comprise no action from the player or user.

The golf system may comprise or use maps or other location specific information. The location specific information may be comprised in the contextual information sent and/or received through the one or more communication interfaces and/or output through the one or more output devices.

The golf system may be configured to use the maps or other location specific information after the monitoring has been completed, for example in order to interpret the information on the performance of the action. For example, the golf system may be or comprise a golf monitoring system, and may comprise or use maps of golf courses in order to determine where a player is or was on a course relative to the landmarks of that course. This may allow the determination of which hole each recorded swing corresponds to, and may facilitate analysis of the information.

The golf system may comprise one or more controllers or processors. The one or more controllers or processors may be or comprise or be comprised in electronic circuits and may be or comprise one or more microcontrollers, ASICs, FPGAs, SoCs, memory chips, and/or other digital or analogue circuitry. At least one of the one or more controllers may be comprised in the one or more portable devices. The one or more controllers may comprise, be comprised in, be connected or connectable to or be configured to communicate with the one or more communication interfaces, the one or more data storage instances, the one or more output devices, the one or more user interfaces, the swing detector, the one or more object sensors, the location sensing device, the tag reader and/or other electronic hardware.

The golf system may be configured to communicate with one or more remote servers through the at least one communication interface. The golf system may be configured to send the gathered information, additional information, internal variables from the at least one portable device, and/or data derived therefrom. The golf system may be configured to receive the maps or other location specific information from the one or more remote servers. The golf system may be configured to communicate with the one or more remote servers via a consumer device, such as a smartphone, tablet or personal computer.

For example, the golf system may be configured to upload the all or part of the gathered information and additional information to a website and/or server. This may allow to player or user to then login to that website in order to access the uploaded information, and/or analysis of the uploaded information.

In general, the golf system may configured to analyse or be configured to allow analysis of the gathered information, in order to produce statistical data. The statistical data may be displayed to the player or user, for example on a consumer device such as a smartphone, or on a website. For example, in a golf monitoring system, the statistical data may include one or more of: the club used on each shot; distance each shot travels; fairways in regulation; greens in regulation; putts per round; longest drive; sand saves; total number of shots; average distance with each club; longest drive; bounce back percentage; and/or up and down percentage. At least some of these statistics may be derived from information gathered over multiple games.

Whilst the examples given above primarily relate to golf, a skilled person would understand that the system is equally usable for a variety of actions. For example, the system may be a football monitoring system and may comprise one or more ankle or leg worn devices, or devices attached to or integrated into boots. The system may then detect when and/or where the player kicks the ball, and log this information, in addition to optionally storing information about the player's movements during a game. Similarly, the system may be a tennis monitoring system, for example using one or more wrist worn devices, or a device integrated into a racquet.

Additionally, the term sound sensor does not limit such a sensor to any specific range of frequencies, and is intended to cover any transducer of acoustic waves.

According to a second example of the present disclosure is a component device of a golf system, the component device comprising a rangefinder system for measuring the distance on the golf course; and at least one coupling for coupling to a second device that comprises at least one of: a positioning system for determining a location of the positioning system on a golf course and at least one statistics collection system for automatically or partially automatically gathering the information on golf statistical performance of the action involving the golfer swinging a golf club or golf equipment to hit or strike or make contact with a golf ball object.

The rangefinder system may be a golf laser rangefinder device. The at least one coupling may be a releasably detachable coupling to releasably attach the second device to the component device, e.g. such that the second device is attachable, releasable and re-attachable to the component device via the coupling. The at least one coupling may be a magnetic coupling, which may comprise a magnet. The magnetic coupling may be configured for magnetically coupling to the second device.

The component device may be the first device described above in relation to the first example.

According to a third example of the present disclosure is a component device of a golf system, the component device comprising at least one of: a positioning system for determining a location of the positioning system on a golf course and at least one statistics collection system for automatically or partially automatically gathering the information on golf statistical performance of the action involving the golfer swinging a golf club or golf equipment to hit or strike or make contact with a golf ball object; the component device comprising a coupling for coupling to a first device, the first device comprising a rangefinder system for measuring the distance on the golf course

The at least one coupling may be a releasably detachable coupling to releasably attach the component device to the first device, e.g. such that the component device is attachable, releasable and re-attachable to the first device via the coupling. The at least one coupling may be a magnetic coupling, which may comprise a magnet. The magnetic coupling may be configured for magnetically coupling to the first device.

The component device may be the second device described above in relation to the first example. The component device may be or comprise a golf device.

The positioning system may comprise a global positioning system, such as GPS, Galileo, GLONASS, BeiDou and/or any other suitable satellite positioning system.

The at least one statistics collection system may comprise a statistical performance tracking device. The at least one statistics collection system may comprise a performance, metric and/or scoring tracking system. The at least one statistics collection system may be configured to communicate with club identification or radio frequency identification tags, which may be inserted into the grip of a golf club to identify the event of a golf shot. The at least one statistics collection system may be configured for identifying a golf shot, and may deliver a system to collect statistical and performance data and performance information through monitoring an action, such as a golf swing or golf shot or recognition of a shot by a golfer. The statistics collection system, may render the device capable to detect and/or identify a tag or multiple tags that identify a golf club type or golf club equipment, e.g. utilising radio frequency and/or Radio Frequency Identification (RFID).

The statistics collection system may comprise of a radio frequency tag reader antenna. The radio frequency tag reader may be or comprise of a tag reader antenna. The component device, optionally the statistics collection system, may comprise of a tag reader circuit. The tag reader circuit maybe or comprise of the tag reader antenna, which may comprise a radio frequency antenna for transmitting and/or receiving electromagnetic power and/or data and/or information. The tag reader circuit may comprise of electronics to manage and/or deliver electrical signals and/or electrical power to the radio frequency antenna. The tag reader may receive data from and/or send data to the at least one radio frequency tag and/or golf club identification tag and/or golf club and/or golf equipment.

The component device, optionally the statistics collection system, may comprise a tag reader, which may comprise the tag reader circuit. The tag reader may utilise a corresponding mode of communication to that used by the at least one tag. The tag reader may be or comprise a wireless tag reader. The tag reader may comprise the tag reader antenna for transmitting and/or receiving electromagnetic radiation. The tag reader antenna may be or comprise an RF or NFC antenna. The tag reader may receive data from and/or send data to the at least one tag.

The tag reader may be comprised in or mounted or mountable on the component device. For example, the tag reader may be comprised in or mounted or mountable on a wrist worn device and/or a device mounted or mountable on the golfer and/or a device attached or attachable to clothing and/or a belt and/or a golf bag. All or part of the tag reader and/or club identification tag reader may be located or locatable on an underside of a device lens and/or a Liquid Crystal Display (LCD) and/or a device logo and/or a device information locational on the device front. The tag reader may comprise of a radio frequency tag reader or golf club identification reader configured such that all or part of the tag reading circuit is located or locatable on the underside of the device logo and/or device information. The component device may comprise a Radio Frequency Identification (RFID) antenna embedded on the lens and/or embedded in the window and/or embedded in the front and/or embedded in the device logo. When the golfer holds the golf club the RFID antenna may communicate with the radio frequency tag and/or golf club identification tag and/or the golf equipment to detect the player and/or golfer is holding the golf club and identify which club is being held.

The component device, e.g. the positioning system and/or the automatic golf statistics performance tracking device thereof, may be configured for data communication, e.g. wireless data communication, with the golf rangefinder device of the first device.

The component device may be a wearable or mountable device, e.g. configured to be wearable or mountable on a wrist, hand, forearm, belt, bag or pocket of the golfer or sports player.

According to a fourth example is a method of assembling or manufacturing a constituent component according to the second or third examples.

The individual features and/or combinations of features defined above in accordance with any aspect of the present invention or below in relation to any specific embodiment of the invention may be utilised, either separately and individually, alone or in combination with any other defined feature, in any other aspect or embodiment of the invention.

Furthermore, the present invention is intended to cover apparatus configured to perform any feature described herein in relation to a method and/or a method of using or producing, using or manufacturing any apparatus feature described herein.

### BRIEF DESCRIPTION OF DRAWINGS

FIG. 1 is a golf distance measuring device illustrating a magnetic detachable device.

FIG. 2 illustrates a magnetic detachable golf distance measuring device and golf statistics performance tracking device.

FIG. 3 illustrates a method to attach magnetically a golf distance measuring device and golf performance tracking device.

FIG. 4 illustrates and shows a radio frequency identification tag capable of identifying a golf club insert in golf grip.

FIG. 5 shows a radio frequency identification tag and/or club identification tag for installation in a golf club component.

FIG. 6 shows a golf distance measuring device rangefinder with magnetic detachable golf distance measuring device and/or gold statistics performance tracking device.

FIG. 7 illustrates the golf distance measuring rangefinder device internals and shows a magnet.

FIG. 8 illustrates a magnetic golf distance measuring device and/or golf statistics performance tracking device on a carry or wearable holder.

FIG. 9 illustrates both front and back side of magnetic golf distance measuring device and/or golf statistics performance tracking device on a carry or wearable holder.

FIG. 10 illustrates the connection between golf distance measuring device and/or golf statistics performance tracking device and radio frequency identification tag and/or club identification tag and golfer and/or user gripping a golf club.

FIG. 11 shows a magnetic golf distance measuring device and/or golf statistics performance tracking device and illustrates the location of the radio frequency identification reader antenna embedded behind the lens and/or behind the LCD and/or behind the logo and/or embedded in the logo.

FIG. 12 shows the magnetic golf distance measuring device and/or golf statistics performance tracking device.

FIG. 13 shows the magnetic golf distance measuring device and/or golf statistics performance tracking device electrical and/or electronic internals.

FIG. 14 illustrates a system for gathering information on the performance of a golfer; sensors and electrical components.

FIG. 15 illustrates a system for gathering information on the performance of a golfer; sensors and electrical components including radio frequency identification sensor.

FIG. 16 illustrates a feedback system to control the radio frequency identification electrical circuit.

FIG. 17 is a flowchart method for using system of FIG. 16.

FIG. 18 illustrates a flowchart method for using on system of FIG. 14 and/or FIG. 15 to detect the presence of a golf club and/or radio frequency identification tag and/or golf club identification tag and detect a golf swing event and/or golf shot event.

FIG. 19 illustrates a series of stages which describe a golf swing and/or golf shot event.

### DETAILED DESCRIPTION OF DRAWINGS

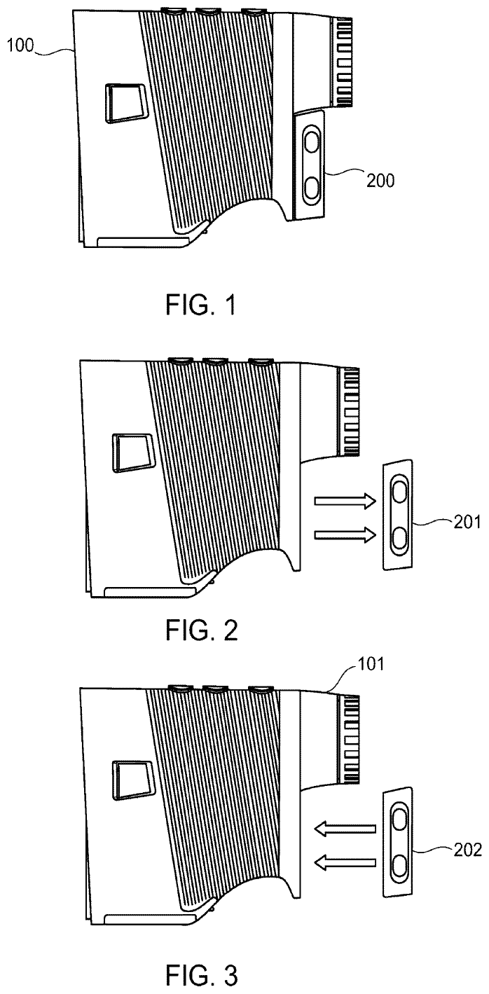

FIG. 1 shows a golf system or device 100 comprising a golf distance measure rangefinder device 101 for gathering distance information specific to golf. The system 100 comprises of a magnetic affixable, mountable or detachable global distance measuring device and/or golf statistics performance tracking or recording or documenting device 200. The device 100 constitutes a golf system. The golf distance measure rangefinder device 101 constitutes a first device, e.g. a golf rangefinder system. The magnetic affixable, mountable or detachable global distance measuring device and/or golf statistics performance tracking or recording or documenting device 200 constitutes a second device. The global distance measuring device functionality constitutes a positioning system. The golf statistics performance tracking or recording or documenting device constitutes a statistics collection system. The golf system 100 may be considered a device.

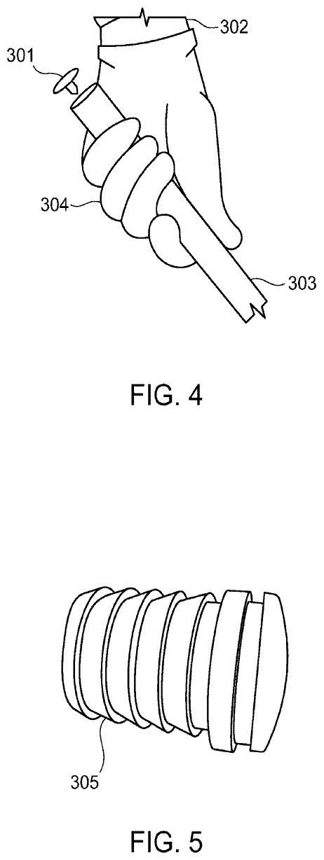

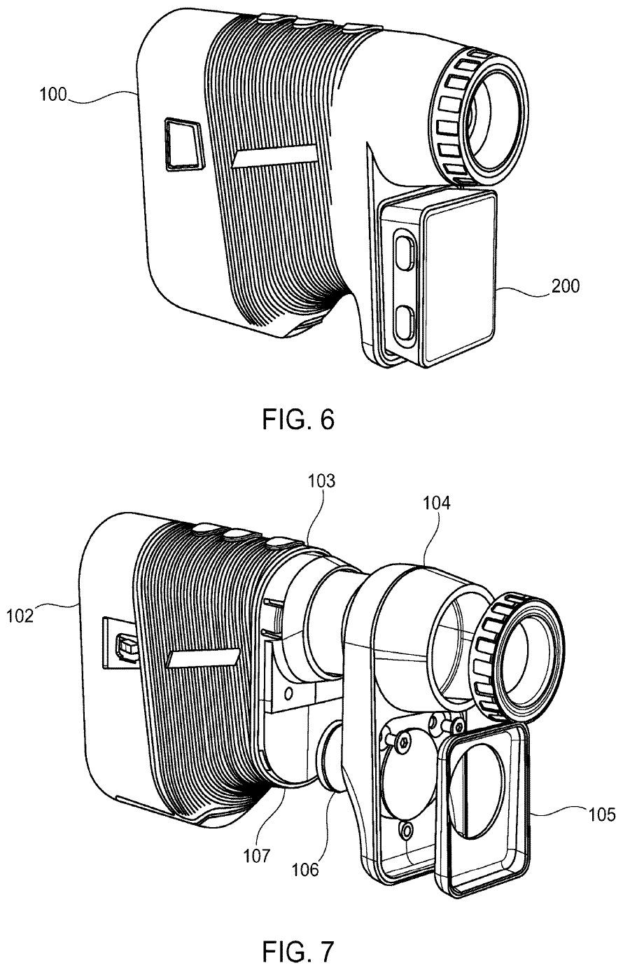

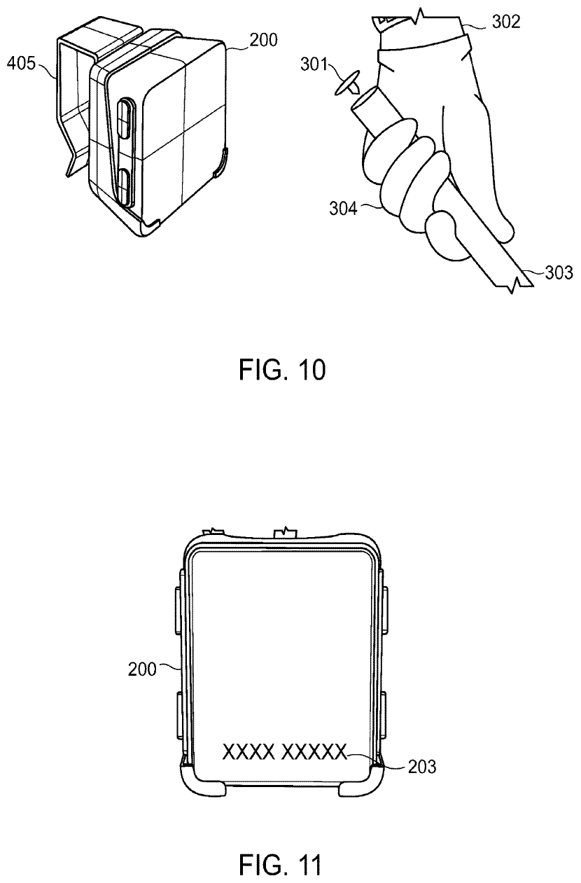

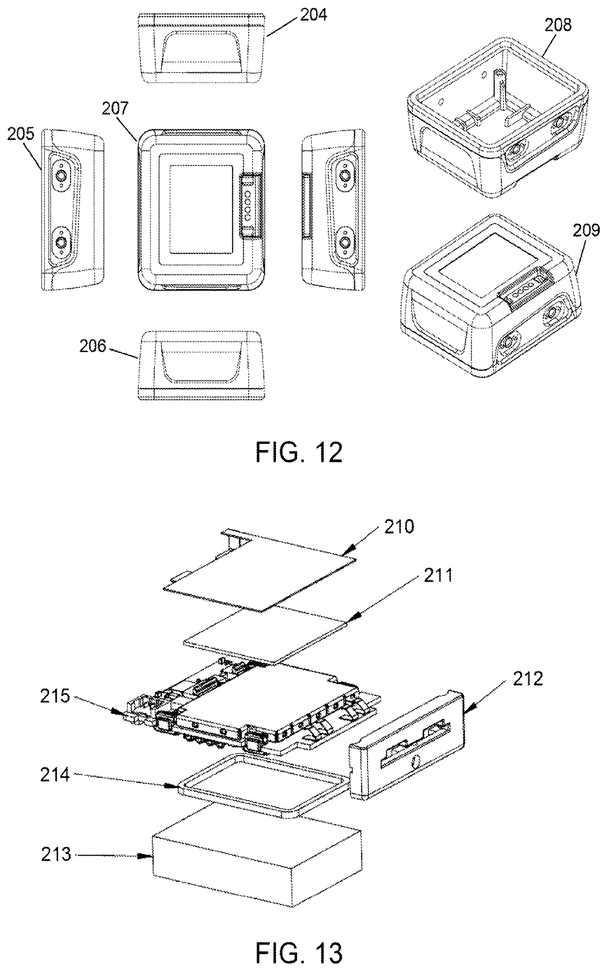

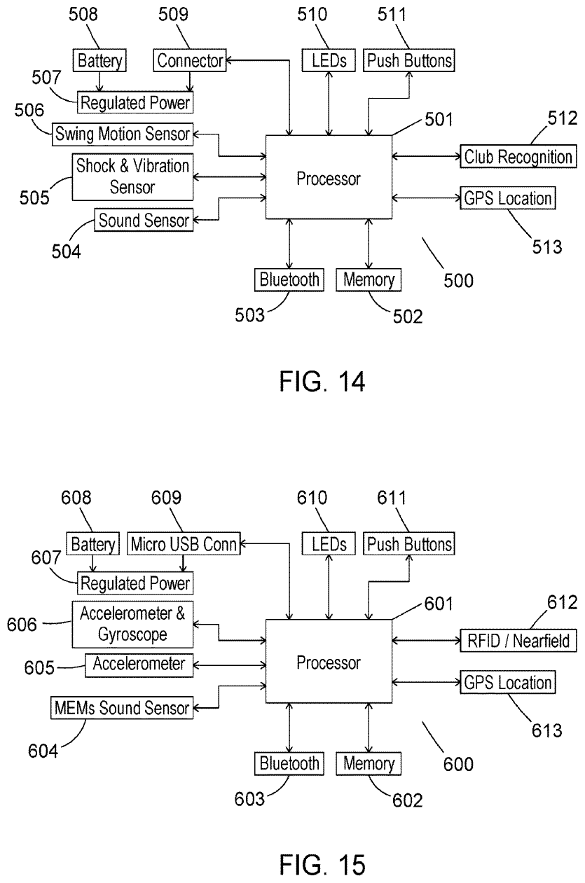

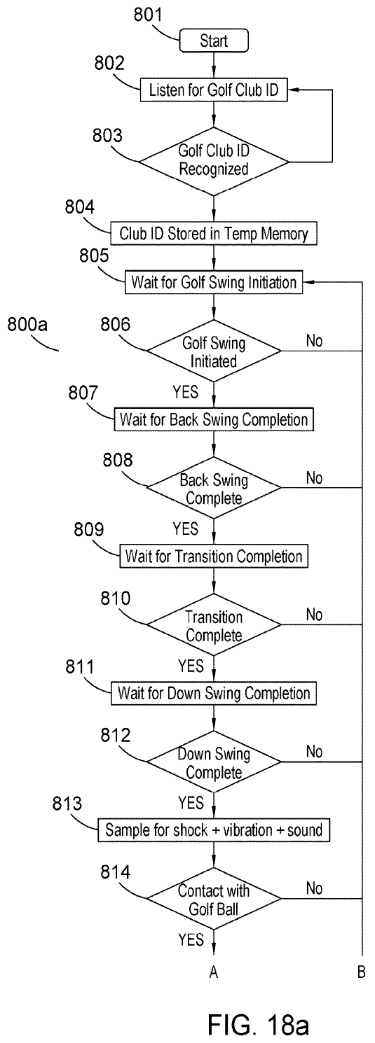

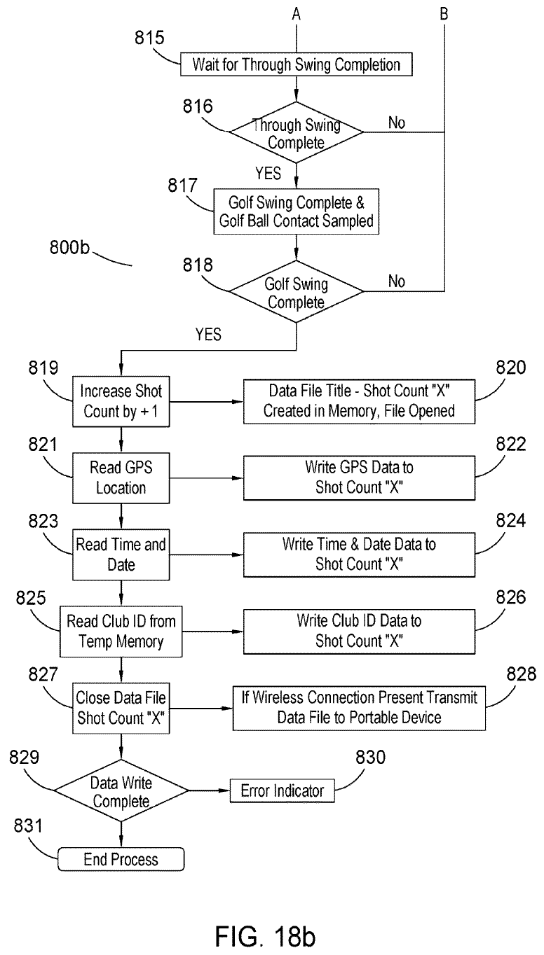

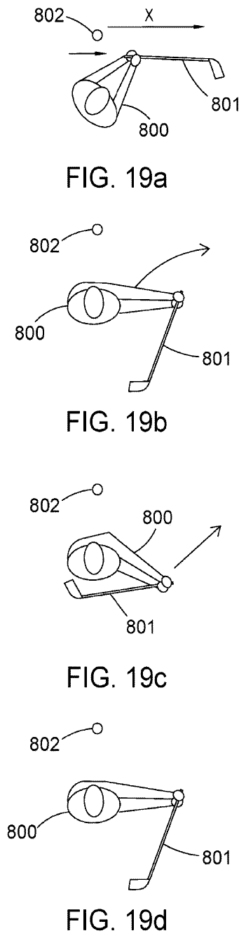

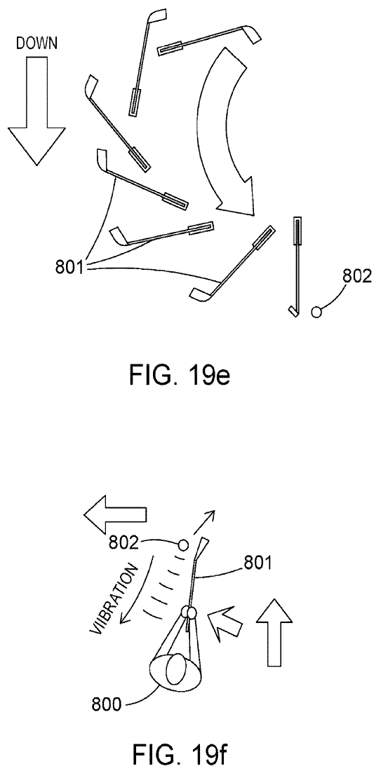

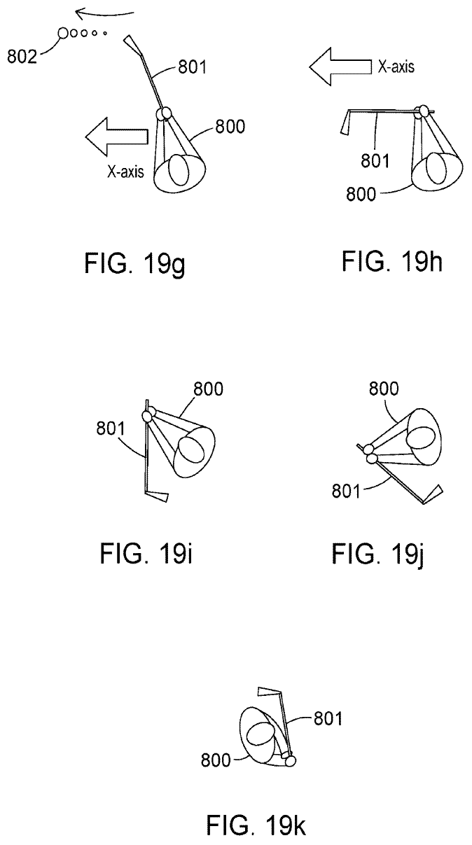

The system 100 comprises of system for measuring and calculating distance on a golf course involving a laser rangefinder device 101, magnetic detachable global positioning device 200, magnetic detachable radio frequency device 200, magnetic detachable golf statistical performance tracking device 200. In this example, the magnetic detachable global positioning device 200, magnetic detachable radio frequency device 200, magnetic detachable golf statistical performance tracking device 200 are combined into a common device 200 and comprised within a common device housing 200. However, in other examples, these may be provided as different devices or only a subset of the devices may be provided. The combination of electrical devices delivers a system capable of identifying the exact position of a golf shot and recording club used to hit the ball (see FIG. 10), latitude and longitude physical location and statistical performance data and information for golf. At least one object sensor and/or radio frequency club identification tag 301 is inserted and/or embedded in the grip or a golf club and/or the golf club component 303 (see FIGS. 4 and 5). One or more of the detachable devices 200 comprise of at least one object or combination of object reading radio frequency sensor 512 and/or swing detection sensor 506 and/or shock sensor 505 and/or vibration sensor 505 (see FIG. 14) and/or accelerometer 605 and/or golf club impact sensor 606 (see FIG. 15) and/or magnetometer sensor and/or sound sensor 504 and 604 (see FIGS. 14 and 15); and the system is configured to at least partially detect a golf swing and/or golf club strike on the ball (see FIG. 18) and/or vibrations as a result of contact with a ball and/or sound generated by contact with a golf ball object. Further use of the detachable device 200 identifying a golf shot delivers a system to collect statistical and performance data and performance information through monitoring an action (see FIG. 19), such as a golf swing and/or golf shot and/or recognition of a shot by a golfer and/or collection of the shot event by a golfer.

Device 100 and device 200 comprise of a magnet 106 specifically located and orientated (see FIG. 7) within device 100 and device 200 to affix, mount or attach device 200 to device 100.

Device 100 and device 200 comprise of a magnetic force (see FIG. 2 and FIG. 3). The magnet and/or magnetic force integrated into device 100 and device 200 results in connecting, affixing, mounting or attaching device 200 to device 100. Both device 100 and device 200 can be detached and/or reattached by the golfer during a game of golf and/or during playing a game or golf and/or playing the sport of golf.

The device 200 comprises of a golf distance measuring system and automatic or partially automatic golf statistical performance tracking and/or collecting and/or recording system. Golf distance measuring data and information is communicated via internal antenna 212. FIG. 11 shows the magnetic portable wearable device 200 specifically for use in golf and/or by a golfer. The device 200 comprises of a radio frequency tag identification reader embedded behind the lens and LCD 210 and/or embedded behind the device logo 203 and/or embedded within the device logo 203.

The device 200 implements or comprises a club reader and/or recognition module 511, which detects when a player is holding a club 303 (see FIG. 10) by detecting a radio frequency identification tag 301 and/or club identification tag 301 on that golf club. The club recognition module 511 communicates with, or simple receives data from, the radio frequency identification tag 301 in order to identify which club 303 the player and/or golfer is holding. For example, the club recognition module 511 may retrieve a unique identification code from the radio frequency identification tag 301 on the club 303.

The device 200 comprises a global positioning sensor module 513 that communicates with a global positioning antenna 212 which tracks the position of the device on the golf course. The location information is retrieved through the Bluetooth module 503 and delivered to a separate consumer electronics device.

The device 200 comprises a Bluetooth module 503, which allows device 200 to communicate, for example with consumer devices such as smartphones and tablets. In this way, the device 200 can send golf distance measurement information and/or golfer locational information and/or golf statistical performance information and/or metrics and/or data and/or insights. Golf statistical performance information or data is derived from one or more of: the swing motion sensor 506, shock and vibration sensor 505, sound sensor 504, accelerometer 605, accelerometer and gyroscope 606, and/or MEMs sound sensor 604. The device 200 is configured to receive additional information or contextual information, for example regarding penalties, location or time data, and such. A memory module 602 of device 200 is used to store and record gathered information, as well as other relevant data.

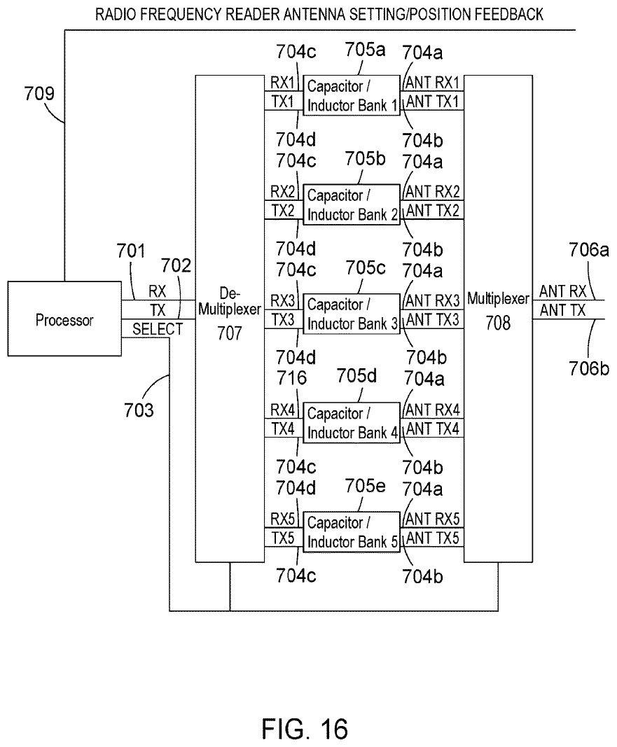

In use, the device 200 both automatically and manually detects that the golfer is holding 304 a golf club 303 and/or golf equipment. The device 200 identifies the club 303 information associated with the radio frequency identifier tag 301 and/or club identification tag 301, for example identifying a driver, wood, hybrid, iron, chipper, wedge or putter club type. The club recognition module 512 is automatically adjusted through feedback from the radio frequency antenna settings and/or position feedback to change settings to deliver an optimum radio frequency electrical and/or electronic and/or circuit settings (see FIG. 16) antenna reader range through output read 706a and output transmit 706b in portable wearable device 200. Upon identification or a golf club, the device 200 activates the swing motion sensor 506 and starts to monitor for a golf swing (see FIG. 18). When the golfer is holding a golf club 801 and is located in the address position at the golf ball 802 the device 200 monitors the outputs from the swing motion sensor 506 and shock and vibration sensor 505 or sound sensor 504 or accelerometer 605 or accelerometer and gyroscope 606 or MEMs sound sensor 604 (see FIG. 14) and uses the readings in combination with the presence of a golf club 303 and radio frequency identification tag 301 and/or club identification tag 301 to identify a golf swing event and/or golf shot event occurred.

In the event of a golf swing event and/or golf shot event occurrence device 200 records and/or stores and/or saves data and information for the event, including one or more of: the time, location, shot count, swing data, golf club type, and/or golf club equipment on the memory module 502. The device 200 programmable circuit 500 may be configured to determine at least one of: a practise swing, golf shot, contact on the golf ball and/or golfer manual entry of a shot as this data may be useful to the golfer and or golf player later in the golf round and/or post the round of golf.

If there is uncertainty the swing event and/or shot event occurred (see FIG. 18 and FIG. 19) the device 200 may record the data and information in relation to the uncertainty in memory 602 and may prompt the golfer that a swing event and/or shot event may have occurred. The golfer can then press a button 511 on device 200 to manually record the event.

The push buttons 511 are used to control the device and provide additional information. The gathering of information can be started/stopped or paused/resumed. Furthermore, in some embodiments the player can press a button 511 to record when they have received a penalty.

FIG. 7 shows a golf distance measuring rangefinder 100 that includes a magnetic or magnetic force 106 to affix, mount or attach device 200. The magnet 106 is embedded, located and oriented specifically to provide a force that holds the portable wearable device 200 securely 202 as a golfer plays the game of golf and/or uses device 100 and device 200 during a round of golf.

FIG. 2 shows a golf distance measuring rangefinder 100 that includes a magnetic or magnetic force 106 and illustrates how device 200 can be detached by a golfer for use during a round of golf.

FIG. 3 shows a golf distance measuring rangefinder 100 that includes a magnetic or magnetic force 106 and illustrates how device 200 can be reattached by a golfer for use during a round of golf or post a round of golf. The magnetic force applied to device 200 results in a secure fitting and attachment to device 100.

FIG. 5 illustrates a radio frequency identification tag 305 and/or club identification tag 305 that provides the same club type identification data and information as radio frequency identification tag 301. In this embodiment, the tag 305 is embedded into the golf club shaft and/or golf club component.

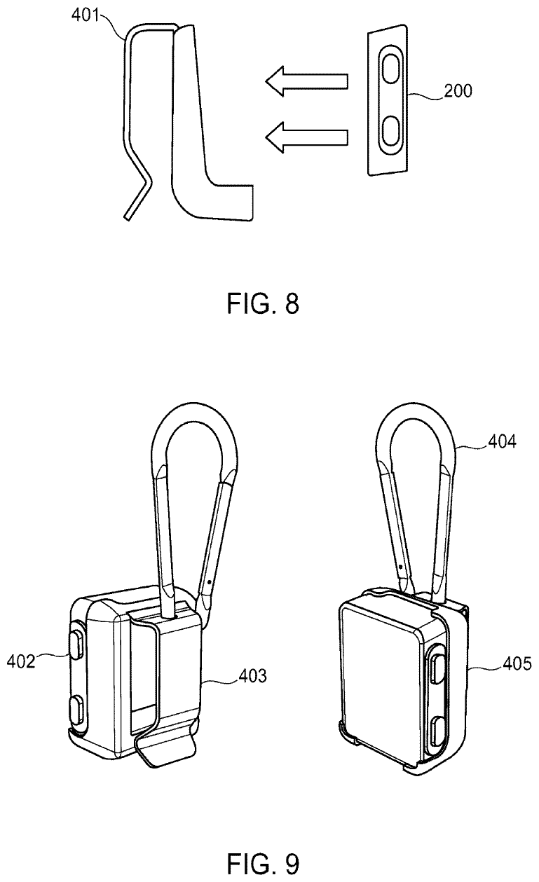

FIG. 8 illustrates device 200 connected or affixed or mounted or attached to a wearable cradle 401 or cradle carrier 401. The golfer may attach the wearable cradle or cradle carrier to clothing and/or belt and/or golf bag and/or golf kart and/or golf buggy.

FIG. 9 illustrates device 200 connected or affixed or mounted or attached to a cradle 405 and carabiner 404 for connecting securely device 200 to a golf bag and/or golf kart and/or golf trolley and/or golf buggy and/or golfer.

FIG. 10 shows a method for detecting a golf swing using motion sensors and contact sensors. A radio frequency identification reader antenna embedded in device 200 capable of seeking and reading a radio frequency identification tag 301 and/or club identification tag 301 and identifying a golf club 304. This occurs when the golfers is holding or gripping the golf club 304. Once a golf club identification has been recognised that club data or information is stored in the memory 502 of device 200.

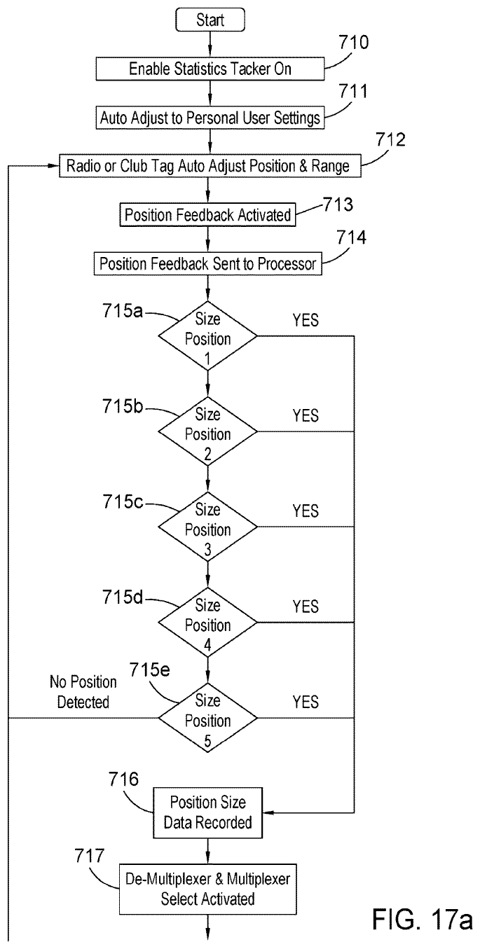

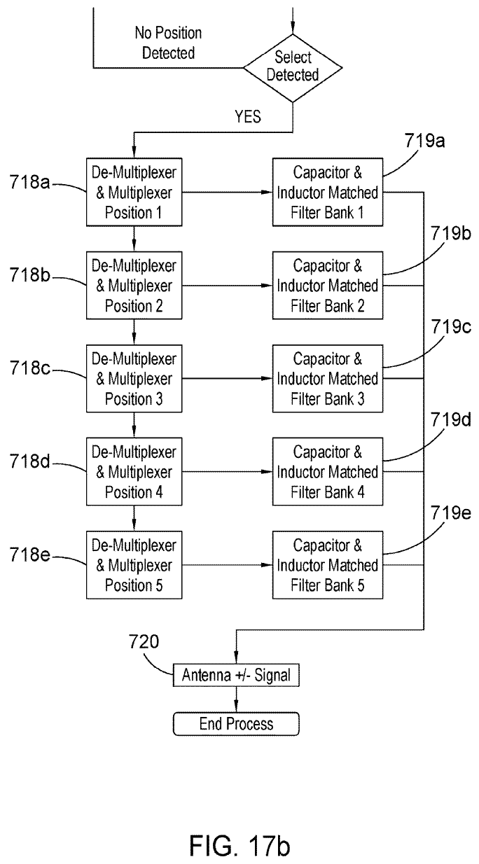

FIG. 16 shows the schematic circuit that illustrates the automatically configurable radio frequency identification reader circuit embedded within device 200. Setting information is returned to the processor 501 from the radio frequency reader antenna setting and position feedback loop or feedback signal 709. The signal measures both the status and range of the electromagnetic field between the device 200 and radio frequency identification tag 301 and/or club identification tag 301. The processor 501 then adjust the electromagnetic field output 706 using a multiplexing process 707 and 708 that adjust electromagnetic field through a bank of inductors and capacitors 705. FIG. 17 shows a flow chart that details the method to automatically configure the electromagnetic antenna read range in device 200. The configurable process is automatic and the golfer or golf player is unaware. Setting the optimal electromagnetic field and optimal read range between device 200 and radio frequency identification tag 301 and/or club identification tag 301.

The device 200 comprises an antenna embedded behind the lens and/or behind the LCD and/or behind the device logo and/or embedded within the device logo. The antenna 203 communicates with the club identification tag 301 located in the golf club handle 303. The antenna behind the lens or behind the LCD or behind the device logo or embedded in the device logo provides a convenient antenna location and arrangement that efficiently communicates through electromagnetic signals to detect a club identification tag 301 and read the club identification data and/or information. However the settings of the antenna can be adjusted to restrict or increase the electromagnetic power and read range in response to the influence of the body of a human user 800 and/or golfer 800 and/or golf player 800. In order to automatically adjust in real-time, a feedback signal 709 constantly monitors and measures the quality of communication between device 200 and tag 301, thereby adjusting the settings and delivering optimal antenna read range performance. The compensation settings mechanism (see FIG. 16) comprises a plurality of matching circuits 705a-e or systems, which have a differing electrical property, such as impedance, capacitance and/or inductance. In one embodiment the antenna conductor is provided on a flexible circuit that fits to the shape of the device 200 lens and/or LCD and/or logo. As indicated above, the compensation settings mechanism comprises of matching circuits or systems, which comprise of capacitor and inductor marched bank filters 705a-e, as shown in FIG. 16. Each capacitor and inductor matched bank filter 705a-e corresponds to, and provides appropriate electrical matching properties for the optimal antenna electromagnetic read range between device 200 and club identification tag 301, there is five possible discrete adjustment settings and/or positions. Controlled by the processor 501 a de-multiplexer 707 and multiplexer 708 selects one of the matched bank filter settings and/or positions that determine the appropriate electromagnetic properties and read range between device 200 and club identification tag 301 reading the golf club data or information and recording and/or saving and/or storing the club in memory 502.

FIG. 17a-b shows a flow chart that details the method to select and set the capacitor and inductor bank within device 200. Position feedback 713 sent to the processor 501 provides the corresponding multiplexer selection 715a-e for optimal antenna power and/or optimal electromagnetic range and/or optimal read range between device 200 and club identification tag 301. The method may help to maintain a better and/or more constant and/or more consistent and/or more sensing range regardless of outside electrical influences or human physical characteristics or golfer characteristics.

If contact with the ball is detected, the device 200 stores the gathered information for the swing, including the time, location, shot count, swing data, club ID, etc., on the memory module 502. The device 200 may also send this information via the Bluetooth module 108, for example to a consumer device such as a smartphone, tablet, or laptop. If contact with the ball is not detected, the device 100 determines that the swing was a practice swing. Depending on configuration settings, the device can still store the information relating to the practice swing, as this may be useful to the player and/or be helpful in later analysis of the data.

FIG. 15 shows a system 600 that may comprise or configured to communicate with radio frequency identification tag 301 or tags and/or club identification tag 301 or tags inserted or mounted or affixable or installed in a golf club 303 and/or golf equipment in the and or gripped 304 by a golfer or golf player or sports player. The at least one tag 301 may comprise, encode or transmit a unique identifier. A radio frequency reader antenna circuit including nearfield 612 and/or Radio Frequency Identification (RFID) sensor 612 may render the system able to detect and/or connect and/or read and/or identify the type of golf club or golf equipment. The at least one tag 301 maybe a passive tag with internal no battery or power. Power is transmitted from device 200 wirelessly utilising electromagnetic force to power the passive tag 301. The at least one tag may utilise radio frequency communication, Near Field Communication (NFC) 612, Wi-Fi communication, Bluetooth communication 603 and/or the like. The at least one tag 301 may be or comprise of a Radio Frequency Identification (RFID) tag. The at least one tag may comprise visual indicia, which may be used to detect and/or identify the tag and/or piece of golf equipment.

The at least one tag 301 or 305 may be designed to be affixable or attachable or insertable or embedded into a piece of golf equipment 303 and/or the grip of the golf equipment. In one embodiment the tag 305 may be located or locatable at least partially inside the golf equipment 303 and/or the grip of the golf equipment. The tag may be configured such that at least part or all of the tag is located or locatable underneath or within a golf grip connected or installed on a golf club and/or a piece of golf equipment.

FIGS. 18a and 18b show a method for detecting a golf swing using motion sensors and contact sensors. The process is started 801, and in steps 802 and 803 seeks a signal from the tag 301 and waits for the detection and identification of a golf club 303 (see FIG. 10). This occurs when the player is holding the club 303, and may be about to take a golf swing or has initiated a golf swing 800 (see FIG. 19a). Once a golf club ID has been recognised, that club ID is stored in memory in step 804. In steps 605 and 606, the method monitors for motions which indicate a golf swing is being initiated, using the swing motion sensor 506 (see FIG. 14) by comparing readings against predetermined patterns or parameter ranges. The predetermined patterns or parameter ranges are determined from analysis and segmentation of data from swing trials for a particular type of swing, for example as shown in FIG. 19. When the method detects that a swing has been initiated, it begins to look for motions which indicate that a back swing is in progress. Step 807 waits for sensor readings which indicate that a back swing is complete, in a predetermined time window. If the time window elapses without the detection of back swing completion, the decision at 808 resets back to step 805, if back swing completion is detected in the appropriate time frame, the method progresses to steps 809 and 810 perform a similar action of monitoring for completion of the transition phase. Steps 811 and 812 do the same for the down swing. At this point, contact with the ball is to be expected if the Swing is a real Swing, as opposed to a practice swing. Step 813 samples for both sound and/or shock and/or vibration and/or acceleration, looking for sensor readings (see FIG. 14) which indicate that contact with the ball has occurred. For example, if the ball has been hit during a drive, a significant decrease in speed and/or acceleration and/or motion can be expected, and this produces a measurable shock, in addition to characteristic vibrations caused by the impact, which can be detected using the shock and vibration sensor 505 (see FIG. 14). In some cases, the decrease in speed and/or motion can be up to 25%, and in other cases even higher. The characteristics of the vibrations caused by the impact may provide information, for example on the quality of the shot. In addition to the shock and vibrations, such a hit will also produce sounds which are measurable using the sound sensor 504. Various methods of analysis are possible for detecting the Sounds and/or shock and vibrations caused by contact with the ball, for example, the method may comprise using one or more of matched filtering or other FIR filtering, frequency spectrum analysis, filtering (e.g. band pass filtering, optionally with Subsequent down sampling), and thresholding. The method can also comprise the use of noise rejection techniques, for example adaptive filtering, to remove background noise. Specific implementations of these and/or equivalent techniques will be apparent to one skilled in the art.

In this example, decision 814 resets the process if no contact is detected. In other examples, the method may continue, but log that the swing was a practice swing, or may assign and/or log a probability that contact occurred. Steps 815 and 816 monitor for the through swing, and steps 817 and 818 check for completion of the swing. Upon successful exiting of step 818, the method stores the relevant information for the swing, including the time and location information as well as the shot count and club identifier. The current shot count is incremented in step 819, and a data file is created and opened for the shot in step 820. The GPS location, time and date, and club ID are read in steps 821, 823 and 825 respectively, and this data is written to the newly opened data file in corresponding steps 822, 824 and 826. The data file is then closed in step 827. In other embodiments, the stored information may include sensor readings from the swing motion sensor 506, shock and vibration sensor 505 and/or sound sensor 504 see FIG. 14), or data derived therefrom. Step 828 ensures that if a wireless, e.g. Bluetooth, connection is present, the data file should be transmitted through that data connection, for example to a consumer device. Step 829 checks that the data write executed successfully, initiating an error handler or indicator 830 if it did not. The process then ends 831, and in use will loop back to step 801 to wait for another swing. The individual phases of a golf shot, for example a drive, are illustrated in FIG. 19a-k, along with indications of the motions which are important for each phase. SubFIGS. 19a-k illustrate the action of a golfer 800 holding a golf club and/or golf equipment 801 striking and/or hitting and/or connecting and/or making a golf shot on a golf ball 802. The same numbering is used throughout the subfigures. References to movements are given for the left wrist of the golfer in this example. The X-axis is Substantially horizontal, and the y-axis is substantially vertical. The Z-axis is also utilised for motion detection. Although changes occurring along the Z-axis are not explicitly described herein, they will be apparent from the diagrams, as well as from analysis of Swing data. Similarly, three-dimensional gyroscopic data is used for motion detection. The patterns of readings which describe Swing phases can be determined from analysis of exemplary Swings. FIG. 19a shows the initiation of the back swing. The player 800 lifts the club 801 and a large change along the X-axis is observed.

FIG. 19b shows the back swing in progress. The left arm is lifting and there is a large change in along the y-axis as the arm lifts towards the sky. There is also further change along the X-axis.

FIG. 19c shows the transition phase at the top of the back Swing, where a change in direction occurs. A significant acceleration should be observable.

FIG. 19d shows the downswing motion as the club travels rapidly down toward the ground, and a large change occurs along the y-axis. FIG. 19e shows the down swing sequency and illustrates the acceleration and downward motion of a golf club 801 toward a golf ball 802. On club 801 contact with the ball a large acceleration and/or shock and/or vibration and/or sound will occur. The electronic and sensor circuit shown in FIG. 14 captures and records the moment the golf club 801 impacts and/or connects and/or hits and/or strikes the golf ball 802.

FIG. 19f shows contact with the ball, wherein a strong force in both X and y directions occurs. The contact with the ball generates shock/vibrations, as well as acoustic waves. Research shows that in some cases a speed reduction of up to 25% occurs due to the contact, although this figure and/or number and/or percentage can be even higher depending on the golfer, Swing type and conditions. In other cases, the speed reduction can be significantly lower.

FIGS. 19g and 19f show the micro second moment post contact referred to as the through swing. The club will have lost speed due to the impact, and continues to slow down. Movement in the X-axis indicates the follow through is occurring.

FIGS. 19i, 19j and 19k show the completion of the golf swing. The club continues to slow, whilst movement occurs upwards along the y-axis. The maximum y-value will be reached as the club 801 reaches the top of the follow through. Finally, there is usually a pause, wherein little motion occurs.

It will be appreciated that each of the above swing stages comprises an indicative motion, pattern, or range of motions which is identifiable using the readings from the swing motion sensor 506, shock and vibration sensor 505, and/or sound sensor 504 (see FIG. 14). For example, inertial forces and/or acceleration due to gravity can be measured by the swing motion sensor 506, and patterns, or ranges of patterns, of these readings for each stage of the swing motion can be ascertained from analysis of exemplary swings. These patterns or ranges can then be used in the detection of each of the relevant swing stages. In use, the device 200 or system or method FIG. 18 may be supplied with such patterns or ranges of patterns preloaded and/or may be able to calibrate.

While certain embodiments have been described, these embodiments have been presented by way of example only, and are not intended to limit the Scope of the invention. Indeed, the novel methods and systems described herein may be embodied in a variety of other forms. Furthermore, various omissions, Substitutions and changes in the form of the methods and systems described herein may be made without departing from the spirit of the invention. The accompanying claims and their equivalents are intended to cover such forms and modifications as would fall within the Scope of the invention.

For example, although various specific examples are given in relation to the game of golf and a device or system to measure distance device for golf and golf statistical performance tracking. The system or device in a different form within the scope of this patent and/or information and/or specification may be used in other sports or actions, for example, tennis, badminton, baseball, squash, cricket, football or rugby.

The following are features that could optionally apply individually or in any combination to any of the examples or embodiments given above or and also form additional examples.

According to an example is a system for measuring the distance on the golf course and automatically or partially automatically gathering information on golf statistical performance on a performance of an action involving a golfer swinging a golf club or golf equipment to hit or strike or make contact with a golf ball object.

The golf system may comprise one or more of the at least one object contact sensor and/or swing movement and/or motion and/or acceleration sensor, which may at least partially detect a golf swing and/or detects the event of a golf club striking a golf ball. One or more golf distance measuring or golf statistical performance tracking devices may be affixable or mountable or attachable to connectable using a magnet or magnetic force. The system may automatically gather golf statistical performance data and/or information and/or insights and/or metrics on a performance of a golfer performing a golf swing action in which that golfer uses a golf club or golf equipment to hit or strike or make contact with a golf ball object. The system may comprise or may be comprised of a golf measurement device wearable and/or attachable and/or portable that can be used for a golfer during playing the game of golf and/or a round of golf. The system may comprise of a magnet of magnetic force that is affixable or mountable or attachable to a golf troller and/or golf kart and/or golf buggy. The system may be adapted to automatically of partially detect when a golf club and/or piece of golf equipment is being gripped by a golfer and/or used by a golfer and/or a golfer is swinging. The system may comprises or may be configured to communicate with one or more radio frequency identification tags and/or club identification tags applied, affixed, affixable, inserted or embedded to a piece of golf club equipment. All or part of the club identification tag may be inserted, installed, embedded or connected to a piece of golf equipment. The system may comprise of a tag reader antenna embedded behind and/or inside and or within the lens or LCD window. The system may identify the event of a golf swing and/or the event of a strike or hit or connection with a golf ball object and the type of golf equipment used. The system May comprise of a radio frequency reader and transmitter with automatically selected range settings by selecting and/or varying one or more matching circuits or matching system based on input range feedback between system and tag. The tag reader antenna circuit may automatically or partially automatically reads the information on a club identification tag to identify a golf club and/or golf equipment type. The golf swing detector may be configured to monitor the at least one golf swing event for predefined motion ranges in a predefined order and/or predefined time window.

The system may be configured to collect one or more; locational data, time data, golf equipment type, swing data derived from at least one swing sensor and/or motion sensor and/or contact sensor, golf shot count, golf score, golf statistical performance data and information. The system may comprise of a club identification and/or radio frequency identification antenna configured to communicate with a club identification tag installed and/or embedded behind or within or inside the lens window or LCD window or logo located on the lens window. The system may comprise a radio frequency antenna and/or club identification antenna located behind and/or embedded within the device logo on the device lens window. The club identification antenna may be embedded and/or integrated to the device logo. The system may comprise of a magnetic force to connect a golf measuring device and/or golf statistical performance tracking device to a piece of equipment. The golf measuring device may comprise of a magnetic force that connects one or more golf measuring sub-device and/or golf statistical performance tracking sub-device.

The system may comprise of a plurality of antenna circuits or systems, and/or an adjustable matching circuit or system, wherein the system may be configured to adjust at least one operating parameter of, or compensation for, the antenna by selecting and/or varying one or more of the matching circuits or systems based on feedback from the read range between device and club identification tag.

The system may be configured to identify and differentiate between a practise golf swing and real golf swing that hit or strike or make contact with the golf ball using a piece of golf equipment, wherein contact with the golf ball object occurs in a real golf swing, by using one or more of the contact and/or motion and/or accelerometer and/or swing and/or sounds sensors to determine whether or not contact with the golf ball object occurred. The system may be configured to use a cluster of swing information; location, position, motion, acceleration in conjunction with the presence of a club identification tag to determine the event of a golf swing and/or golf shot.

The system may be configured to communicate with one or more portable electronic device to share golf measurement data and/or information and golf statistical performance tracking data and/or information specific to the game of golf or sport and/or sport of golf. The system may be configured to automatically record, analyse, document and store golf statistical performance data and/or information in relation to a golfers golf game or measurable performance. The system may be configured to determine an event of a real golf swing or real golf shot utilising a set of predefined characteristics in relation to the position, acceleration, force, vibration throughout a golf swing and the event of contact with the golf ball object.

According to an example is a system for automatically gathering golf measurement information and golf statistical performance information on a performance of an action involving a golfer swinging motion with a golf club gripped in hand, the system comprising: one or more swing and/or motion sensors, the at least one swing sensor being comprising one or more inertial sensors; the system being configured to detect swing motions based at least on the data and information from the swing sensor; wherein the system is configured to monitor swing and/or motion and/or acceleration and/or vibration and/or sound sensors for pre-defined golf swing motions and/or golf swing movements across a pre-defined time window.

According to an example is a portable device comprising of a golf distance measuring device and golf statistical performance tracking device connected or affixed or attachable using magnets and/or magnetic force.

According to an example is a system comprises of both golf distance measuring and golf statistical performance tracking in a wearable or portable device.

According to an example is an automatic electronic golf statistical performance tracking device that captures the event of a golf shot fully or partially automatically to deliver personal golf score, personal golf statistical data, personal golf metric data, personal golf insight data for use on the golf course during playing the game of golf and/or a round of golf.

Method steps of the invention can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customised circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a screen, e.g., a CRT (cathode ray tube), plasma, LED (light emitting diode) or LCD (liquid crystal display) monitor, for displaying information to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

1. A golf system comprising:
a system for measuring the distance on the golf course; and
a statistics collection system for automatically or partially automatically gathering statistical information on performance of an action involving a golfer swinging a golf club or golf equipment to hit or strike or make contact with a golf ball object.

2. The golf system according to claim 1, comprising at least one sensor, the at least one sensor comprising one or more of:
at least one object contact sensor; a swing movement sensor; a motion sensor; and/or an acceleration sensor; wherein
the at least one sensor is configured to at least partially detect a golf swing and/or detect the event of a golf club striking a golf ball.

3. The golf system according to claim 1, wherein the system for measuring the distance on the golf course comprises a laser rangefinder or other rangefinder.

4. The golf system according to claim 1, wherein the system comprises of a magnetic force to connect one or both of: the system for measuring the distance on the golf course and the statistics collection system to a piece of equipment.

5. The golf system according to claim 4, wherein:
the system for measuring the distance on the golf course is provided in a first device;
the statistics collection system is provided in a second device; and
the first device and second device are affixable or mountable or attachable to connectable together using a magnet or magnetic force.

6. The golf system according to claim 1, wherein the statistics collection system automatically gathers at least one of: golf statistical performance data or information; insights; and metrics on a performance of a golfer performing a golf swing action in which that golfer uses a golf club or golf equipment to hit or strike or make contact with a golf ball object.

7. The golf system according to claim 1, wherein the golf system comprises or is comprised of a golf measurement device that is at least one of: wearable, attachable and portable and that can be used for a golfer during playing the game of golf or a round of golf.

8. The golf system according to claim 1, wherein the golf system comprises of a magnet of magnetic force that is affixable or mountable or attachable to at least one of: a golf trolley, golf kart and golf buggy.

9. The golf system according to claim 1, adapted to automatically or partially detect when a golf club or piece of golf equipment is at least one of: being gripped by a golfer, used by a golfer and a golfer is swinging.

10. The golf system according to claim 9, wherein the golf system comprises or is configured to communicate with one or more radio frequency identification tags or club identification tags applied, affixed, affixable, inserted or embedded to a piece of golf club equipment to automatically or partially detect when the golf club or the piece of golf equipment is at least one of: being gripped by the golfer, used by the golfer and the golfer is swinging.

11. The golf system according to claim 10, wherein all or part of the club identification tag is one of: inserted, installed, embedded or connected to the piece of golf equipment.

12. The golf system according to claim 1, wherein the golf system is configured to identify at least one of: the event of a golf swing, the event of a strike with a golf ball object, the event of a hit with a golf ball object, the event of a connection with a golf ball object, and the type of golf equipment used.

13. The golf system according to claim 10, comprising a radio frequency reader and transmitter with automatically selected range settings that are selectable by selecting or varying one or more matching circuits or matching system based on input range feedback between system and tag.

14. The golf system according to claim 10, wherein the golf system comprises a tag reader antenna circuit that automatically or partially automatically reads the information on a club identification tag to identify a golf club or golf equipment type.

15. The golf system according to claim 14, wherein the tag reader antenna circuit comprises or is configured to communicate with a tag reader antenna embedded behind, inside or within a lens or LCD window of, the golf system.

16. The golf system according to claim 9, wherein golf system comprises a golf swing detector configured to monitor at least one golf swing event for predefined motion ranges in one or both of: a predefined order and predefined time window.

17. The golf system according to claim 1, configured to collect one or more of: locational data, time data, golf equipment type, swing data derived from at least one swing sensor, swing data derived from at least one motion sensor, swing data derived from at least one contact sensor, golf shot count, golf score, golf statistical performance data and information.

18. The golf system according to claim 1, wherein the system comprises at least one of: a radio frequency antenna, a tag reader antenna and a club identification antenna located behind or embedded within the device logo on the device lens window.

19. The golf system according to claim 18, wherein at least one of: the radio frequency antenna, tag reader antenna and club identification antenna is embedded or integrated in to the device logo.

20. The golf system according to claim 1, wherein the golf measuring device comprises of a magnetic force that connects the system for measuring the distance on the golf course and the statistics collection system.

21. The golf system according to claim 1, wherein the system comprises of a plurality of antenna circuits or systems and one or more adjustable matching circuit or system, wherein the golf system is configured to adjust at least one operating parameter of, or compensation for, the antenna by selecting or varying one or more of the matching circuits or systems based on feedback from the read range between device and club identification tag.

22. The golf system according to claim 1, wherein the golf system is configured to identify and differentiate between a practise golf swing and real golf swing that hits or strikes or makes contact with the golf ball using a piece of golf equipment, wherein contact with the golf ball object occurs in the real golf swing, the identification and differentiation using one or more of: the contact, motion, accelerometer, swing and sounds sensors to determine whether or not contact with the golf ball object occurred.

23. The golf system according to claim 1, wherein the golf system is configured to use a cluster of at least one or each of: swing information; location, position, motion, and acceleration, in conjunction with the presence of a club identification tag to determine the event of a golf swing or golf shot.

24. The golf system according to claim 1, wherein the golf system is configured to communicate with one or more portable electronic device to share golf measurement data or information and golf statistical performance tracking data or information specific to the game of golf or sport or sport of golf.

25. The golf system according to claim 1, wherein the golf system is configured to automatically record, analyse, document and store golf statistical performance data and/or information in relation to a golfers golf game or measurable performance.

26. The golf system according to claim 22, wherein the system is configured to determine an event of a real golf swing or real golf shot utilising a set of predefined characteristics in relation to at least one or each of: the position, acceleration, force, and vibration throughout a golf swing and the event of contact with the golf ball object.

27. (canceled)

28. A portable device comprising of a golf distance measuring device and golf statistical performance tracking device connected or affixed or attachable using magnets or magnetic force.

29. (canceled)

30. An automatic electronic golf statistical performance tracking device that captures the event of a golf shot fully or partially automatically to deliver at least one of: personal golf score, personal golf statistical data, personal golf metric data, and personal golf insight data for use on the golf course during playing the game of golf or a round of golf.

31. A device for measuring the distance on the golf course, the device configured to determine a distance to features on a golf course, the device further comprising a magnetic coupler for coupling to a second device, the second device comprising at least one or both of: a positioning system for determining the location of the second device on the golf course; and a statistics collection system for automatically or partially automatically gathering statistical information on performance of an action involving a golfer swinging a golf club or golf equipment to hit or strike or make contact with a golf ball object.

32. The device of claim 31, wherein the device is or comprises a laser rangefinder or other rangefinder.

33. The device of claim 31 further comprising a communications module for communicating with the second device, the communications module configured to at least one of: communicate the determined distance to features on a golf course to the second device and receive at least one of: the location on the golf course and the statistical information on performance of an action from the second device.

34. (canceled)

35. (canceled)

36. (canceled)

37. (canceled)

38. (canceled)

39. A system comprising a device for measuring the distance on the golf course and a golf device that comprises at least one or both of: a positioning system for determining the location of the second device on the golf course; and a statistics collection system for automatically or partially automatically gathering statistical information on performance of an action involving a golfer swinging a golf club or golf equipment to hit or strike or make contact with a golf ball object;
wherein the device for measuring the distance on the golf course and the golf device are releasably couplable together via magnetic force.

40. A method of producing a device for measuring the distance on the golf course, the device configured to determine a distance to features on a golf course, the method comprising providing the device with a magnetic coupler for coupling to a second device, the second device comprising at least one or both of: a positioning system for determining the location of the second device on the golf course; and a statistics collection system for automatically or partially automatically gathering statistical information on performance of an action involving a golfer swinging a golf club or golf equipment to hit or strike or make contact with a golf ball object.

41. A method of producing a golf device, the method comprising providing the golf device with a magnetic coupler and at least one or both of: a positioning system for determining the location of the golf device on a golf course and a statistics collection system for automatically or partially automatically gathering statistical information on performance of an action involving a golfer swinging a golf club or golf equipment to hit or strike or make contact with a golf ball object, wherein the magnetic coupler is configured to couple with a device for measuring a distance on the golf course.

42. A method of using the system of claim 39, comprising magnetically attaching the device for measuring the distance on the golf course to the golf device and subsequently detaching the golf device from the device for measuring the distance on the golf course, or vice-versa.

43. The method of claim 42, comprising using the golf device to one or both of:
communicate with one or more radio frequency identification tags or club identification tags applied, affixed, affixable, inserted or embedded to a piece of golf club equipment to automatically or partially detect one or more of: when the golf club or the piece of golf equipment is being gripped by the golfer or used by the golfer and the golfer is swinging; and
detect a golf swing and/or detect the event of a golf club striking a golf ball.
